(19) United States
(12) Patent Application Publication
(10) Pub. No.: US 2026/0053277 A1
(43) Pub. Date: Feb. 26, 2026

(54) Multifunctional Cup Dispenser

(71) Applicant: Dehua Qiu, Hengyang County (CN)

(72) Inventor: Dehua Qiu, Hengyang County (CN)

(21) Appl. No.: 18/986,733

(22) Filed: Dec. 19, 2024

(30) Foreign Application Priority Data
Aug. 20, 2024 (CN) 2024220191034

(51) Int. Cl. A47F 1/06; B65G 1/07

(52) U.S. Cl. CPC A47F 1/065; B65G 1/07

(57) ABSTRACT

A multifunctional cup dispenser, comprising a cup tube, wherein a cabinet-mounted seat is snap-fitted on top of the cup tube. On the side of the cabinet-mounted seat away from the cup tube, an adjustable cup pressing assembly is provided. A cup pushing assembly is arranged inside the cup tube. The present utility model belongs to the field of food and beverage technology and specifically relates to a multifunctional cup dispenser. It overcomes issues such as the cup body being exposed outside and occupying a large space, the dispensing outlet having a fixed diameter that cannot accommodate disposable cups of various diameters, and the occurrence of dispensing abnormalities during the cup dispensing process.

### FIELD OF THE INVENTION

The present invention relates to the field of food and beverage equipment, and more specifically, to a multifunctional cup dispenser.

### BACKGROUND OF THE INVENTION

Currently, commercially available cup dispensers are commonly installed on cabinet-like fixtures, with the cup dispensing opening exposed outside. Some cup dispensers have a relatively small portion of the dispensing opening exposed, but since the diameter of the dispensing opening is fixed, it is difficult to accommodate disposable cups of different sizes. Other cup dispensers have an adjustable mechanism at the dispensing opening, but such openings often protrude significantly, increasing the space occupied and making installation and use in certain scenarios difficult.

In addition, when stacked cups are placed inside a cup dispenser, because their overlapping length is large, and once they enter the dispenser deeply, gravity can cause the cups to shift. This may lead to the cups pressing against the dispensing opening and cause dispensing irregularities. Furthermore, when a pusher mechanism pushes the cups into position, the stacked cups, influenced by gravity, may press down on the silicone flaps at the outlet, causing misalignment, abnormal stress on the silicone piece, and difficulty in dispensing cups.

### SUMMARY OF THE INVENTION

The technical problems to be solved by the present invention include: large spatial occupation due to exposed cup bodies, a fixed dispensing opening diameter that cannot accommodate disposable cups of different diameters, and frequent dispensing irregularities.

To solve the above technical problems, the present invention adopts the following technical solution: A multifunctional cup dispenser is provided, comprising a cup tube, wherein a cabinet-mounted seat is snap-fitted on top of the cup tube. On the side of the cabinet-mounted seat away from the cup tube, there is an adjustable cup pressing assembly, and inside the cup tube, there is a cup pushing assembly.

As an improvement, the adjustable cup pressing assembly includes a housing and a face cover. The housing is provided on the cabinet-mounted seat, and the face cover is snap-fitted to the housing. A regulating ring is rotatably arranged inside the housing. The inner wall of the housing is provided with a locating opening. Gears, elastic pieces, and cup separation assemblies are arranged in an array around the circumference of the regulating ring inside the housing. The gears mesh with the regulating ring. The elastic pieces are clamped between the inside of the housing and the regulating ring. The cup separation assemblies slide within the locating openings and are connected to the gears.

As an improvement, the cup separation assembly includes a fixed seat, a shaft, a torsion spring, a claw head, and a hanging platform. The fixed seat is slidably connected to the locating opening. The gear is connected to the fixed seat. The shaft is provided within the fixed seat, and the torsion spring is sleeved on the shaft. The claw head is connected to the fixed seat via the shaft, and the hanging platform is fitted on the side of the claw head opposite the fixed seat.

As an improvement, the top wall of the fixed seat is provided with an adjustment slot. An eccentric adjusting pushrod is eccentrically disposed at the bottom of the gear and is slidably connected to the adjustment slot.

As an improvement, four sets of adjusting teeth are arranged in an array on the circumferential side wall of the elastic piece. The adjusting teeth are meshed with the gears.

As an improvement, the cabinet-mounted seat includes a mounting seat and a silicone ring. The mounting seat connects the cup tube and the housing. The locating opening penetrates the mounting seat, corresponding in position to the housing. The silicone ring is included at the connecting portion between the mounting seat and the cup tube.

As an improvement, the cup pushing assembly includes a cup pushing spring and a push block. The cup pushing spring is provided on the bottom inner wall of the cup tube, and the push block is connected to the cup pushing spring and arranged inside the cup tube.

As an improvement, the cup tube is composed of upper and lower tubular sections.

As an improvement, the hanging platform is shaped like an inverted “L,” with one side angled and the other side wavy. The angled side of the hanging platform conforms to the shape of the cup and guides it.

By adopting the above structure, the present invention achieves the following advantageous effects:

The multifunctional cup dispenser proposed in this solution overcomes the issues in existing cup dispensers where the cup body is exposed, increasing spatial occupation and causing difficulty in installation and use in certain scenarios. By providing an adjustable cup pressing assembly, the invention can securely hold disposable cups of different diameters without the cups protruding outside. By configuring the hanging platform with an angled side combined with a wavy edge, and using silicone material, rapid and accurate positioning of the cups is achieved, preventing dispensing irregularities.

### BRIEF DESCRIPTION OF THE DRAWINGS

FIG. 1 is a schematic view of the overall structure of the multifunctional cup dispenser proposed by the present invention;

FIG. 2 is another schematic structural view of the multifunctional cup dispenser proposed by the present invention;

FIG. 3 is a cross-sectional view of the multifunctional cup dispenser of the present invention;

FIG. 4 is an exploded schematic view of the adjustable cup pressing assembly of the present invention;

FIG. 5 is a cross-sectional top view of the multifunctional cup dispenser of the present invention;

FIG. 6 is an exploded view of the cup separation assembly of the present invention;

FIG. 7 is a schematic view of the structure of the fixed seat proposed by the present invention;

FIG. 8 is a schematic view of the structure of the gear proposed by the present invention.

### DETAILED DESCRIPTION OF THE EMBODIMENTS

Below, the technical solutions in the embodiments of the present invention will be clearly and completely described in conjunction with the accompanying drawings. It is apparent that the described embodiments are only part of the embodiments of the present invention, not all of them. Based on the embodiments of the present invention, all other embodiments obtained by those skilled in the art without creative efforts fall within the protection scope of the present invention.

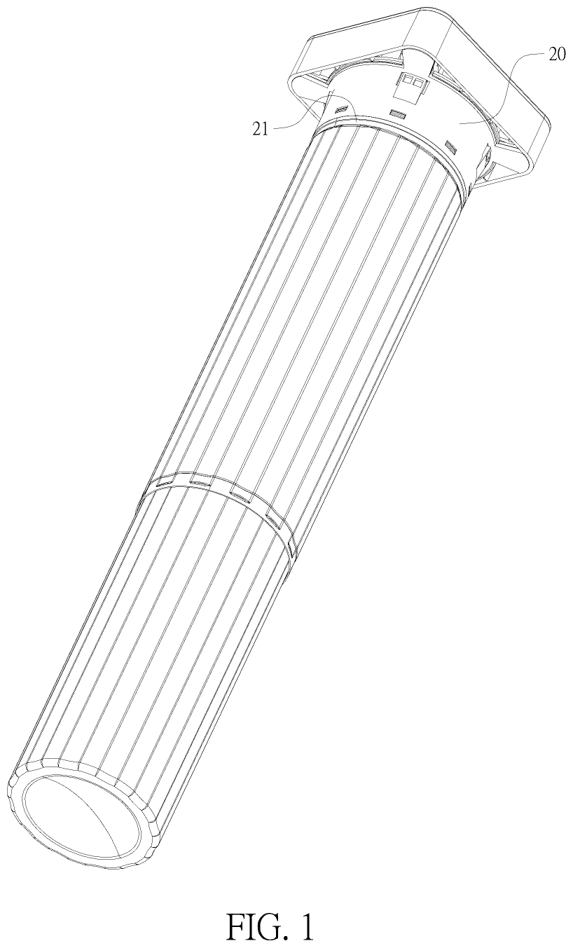

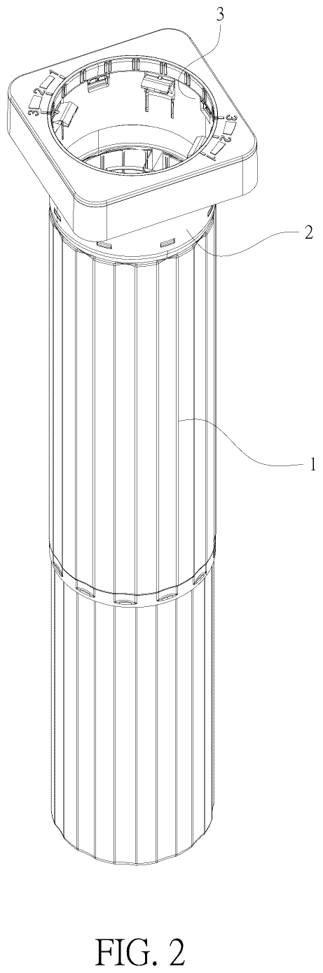

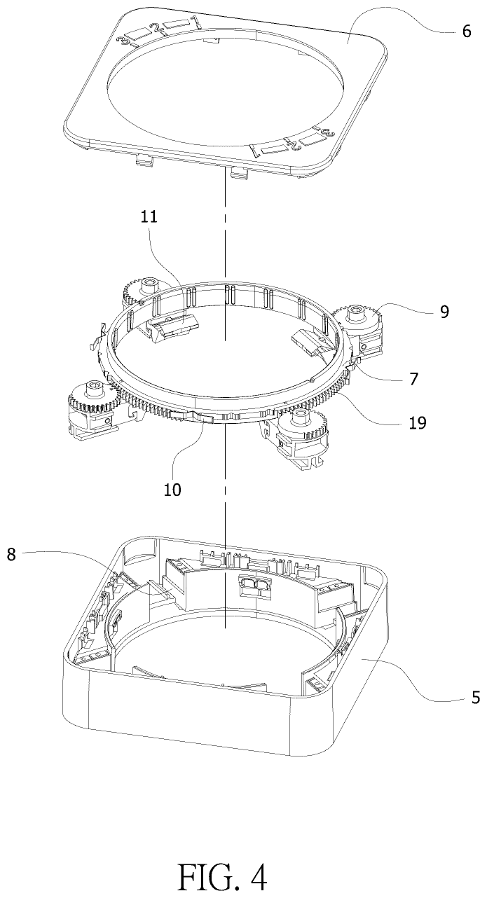

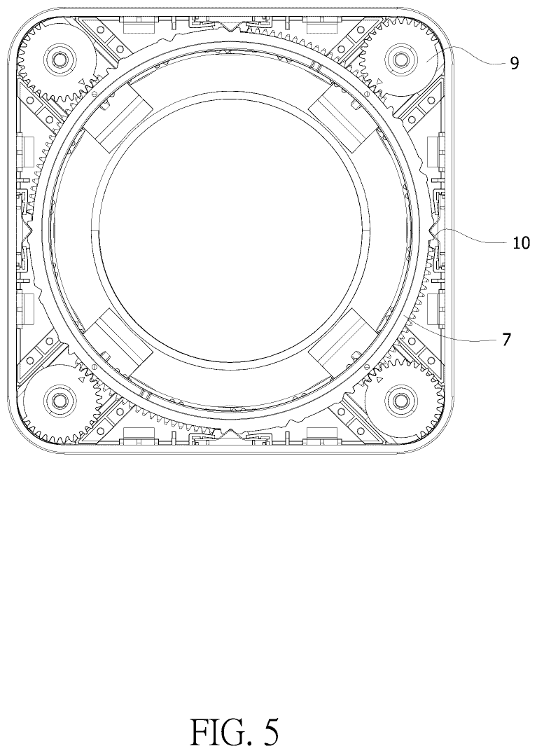

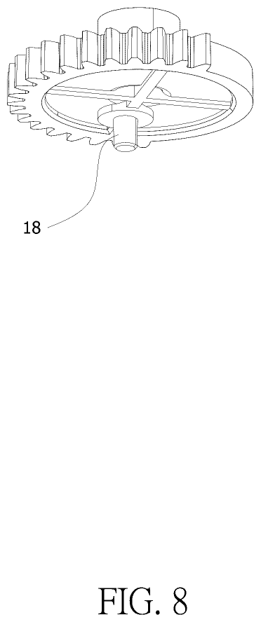

As shown in FIGS. 1-8, the multifunctional cup dispenser proposed by the present invention comprises a cup tube 1. A cabinet-mounted seat 2 is snap-fitted above the cup tube 1. The cup tube 1 is formed by upper and lower tubular sections. On the side of the cabinet-mounted seat 2 away from the cup tube 1, there is provided an adjustable cup pressing assembly 3. Inside the cup tube 1, there is a cup pushing assembly 4.

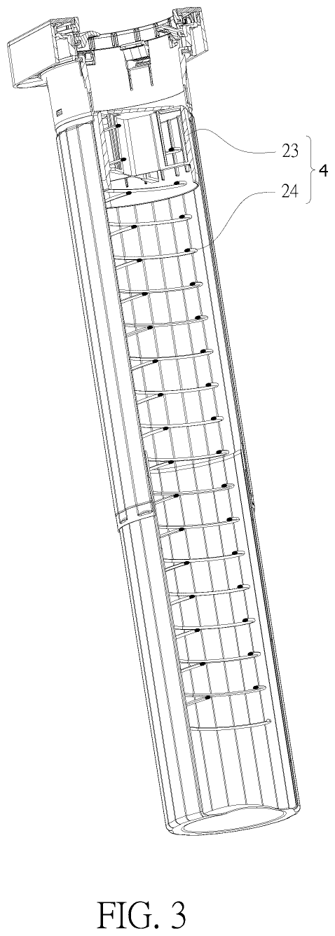

As shown in FIGS. 3-5 and 8, the adjustable cup pressing assembly 3 includes a housing 5 and a face cover 6. The hanging platform 16 is shaped like an inverted “L,” with one side angled and the other side wavy. The angled side of the hanging platform 16 conforms to the cup's shape to guide the cup. The housing 5 is provided on the cabinet-mounted seat 2, and the face cover 6 is snap-fitted onto the housing 5. A regulating ring 7 is rotatably arranged inside the housing 5. The inner side wall of the housing 5 is provided with a locating opening 8. Around the regulating ring 7 inside the housing 5, gears 9, elastic pieces 10, and cup separation assemblies 11 are arranged in a circumferential array. The gears 9 mesh with the regulating ring 7. An eccentric adjusting pushrod 18 is eccentrically provided at the bottom of each gear 9. The elastic pieces 10 are clamped between the housing 5 and the regulating ring 7. Four sets of adjusting teeth 19 are arranged in an array on the circumferential side wall of each elastic piece 10, and these adjusting teeth 19 mesh with the gears 9. Each cup separation assembly 11 slides in the locating opening 8 and is connected to a corresponding gear 9.

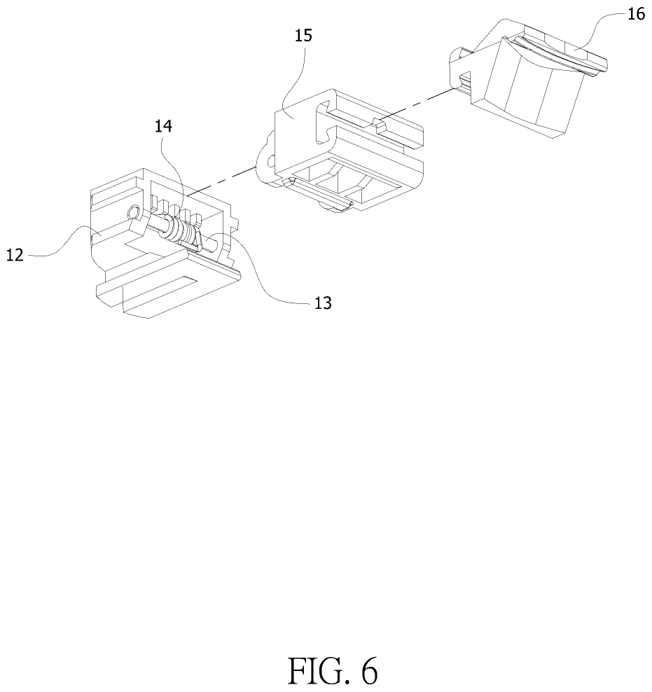

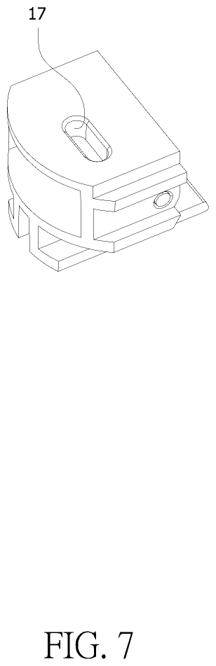

As shown in FIGS. 6 and 7, each cup separation assembly 11 includes a fixed seat 12, a shaft 13, a torsion spring 14, a claw head 15, and a hanging platform 16. The fixed seat 12 is slidably connected to the locating opening 8. The top wall of the fixed seat 12 has an adjustment slot 17. The eccentric adjusting pushrod 18 on the gear 9 is slidably connected to the adjustment slot 17. The gear 9 is connected to the fixed seat 12. The shaft 13 is arranged inside the fixed seat 12. The torsion spring 14 is sleeved on the shaft 13. The claw head 15 is connected to the fixed seat 12 via the shaft 13. The hanging platform 16 is fitted on the side of the claw head 15 opposite the fixed seat 12.

As shown in FIG. 1, the cabinet-mounted seat 2 includes a mounting seat 20 and a silicone ring 21. The mounting seat 20 connects the cup tube 1 and the housing 5. The locating opening 8 penetrates the mounting seat 20 at a corresponding position to the housing 5. The silicone ring 21 is included at the connection between the mounting seat 20 and the cup tube 1.

As shown in FIG. 3, the cup pushing assembly 4 includes a cup pushing spring 22 and a push block 23. The cup pushing spring 22 is arranged on the bottom inner wall of the cup tube 1, and the push block 23 is connected to the cup pushing spring 22 and arranged inside the cup tube 1.

In practical use, stack the cups upside down and place them into the cup tube 1. The rim of the first cup rests on the push block 23. After stacking multiple cups into the cup tube 1, push all the stacked cups inward once by hand, moving them further away from the adjustable cup pressing assembly 3. At this moment, the cup pushing spring 22 is highly compressed and thus has a large rebound force. Then release the cups, allowing the cup pushing spring 22 and the push block 23 to push the stacked cups towards the position of the claw head 15 and the hanging platform 16, thus achieving a locked position. Because the hanging platform 16 has an angled edge, it effectively prevents the cups from becoming skewed or difficult to dispense due to excessive stacking depth. It also prevents any scenario where cups fail to contact the hanging platform 16 during dispensing.

Moreover, the user can adjust the position of the hanging platform 16 according to the cup size. By rotating the regulating ring 7, the regulating ring 7 causes the four sets of gears 9 to rotate. The eccentric adjusting pushrod 18 on each gear 9 rotates circumferentially within the adjustment slot 17 of the fixed seat 12. Under the constraint of the locating opening 8, the fixed seat 12, claw head 15, and hanging platform 16 cannot rotate circumferentially, only move towards or away from the center of the cup tube 1. This adjustment allows the hanging platform 16 to approach or retreat from the cup's edge so that, under the angled edge configuration, it always fits snugly against the cup's circumference. When a cup is taken, due to the hanging platform 16 being made of rubber-like material and its wavy edge configuration, it can quickly and elastically return after the cup is removed, pressing and securing the next cup properly.

Although certain embodiments of the present invention have been disclosed and described, various changes, modifications, substitutions, and variations can be made by those skilled in the art without departing from the principles and spirit of the present invention. The scope of the present invention is defined by the appended claims and their equivalents.

The above description of the present invention and its embodiments is illustrative and not limiting. The structures shown in the drawings represent only one embodiment of the invention and do not limit the actual structure. In summary, if those skilled in the art are inspired by the teachings herein and make similar structural forms or embodiments without departing from the spirit of the invention, all should fall within the protection scope of the present invention.

I claim

1. A multifunctional cup dispenser, comprising
a cup tube (1);
a cabinet-mounted seat (2) snap-fitted onto a top of the cup tube (1);
an adjustable cup pressing assembly (3) provided on a side of the cabinet-mounted seat (2) that is away from the cup tube (1); and
a cup pushing assembly (4) arranged inside the cup tube (1).

2. The multifunctional cup dispenser according to claim 1, wherein the adjustable cup pressing assembly (3) comprises a housing (5) and a face cover (6), the housing (5) is provided on the cabinet-mounted seat (2) and the face cover (6) is snap-fitted onto the housing (5), a regulating ring (7) is rotatably arranged inside the housing (5), a locating opening (8) is formed on the inner side wall of the housing (5), gears (9), elastic pieces (10), and cup separation assemblies (11) are arranged in an array around the circumference of the regulating ring (7) inside the housing (5), the gears (9) mesh with the regulating ring (7), the elastic pieces (10) are clamped between the interior of the housing (5) and the regulating ring (7), and each cup separation assembly (11) slides within the locating opening (8) and is connected to a corresponding gear (9).

3. The multifunctional cup dispenser according to claim 2, wherein each cup separation assembly (11) comprises a fixed seat (12), a shaft (13), a torsion spring (14), a claw head (15), and a hanging platform (16); the fixed seat (12) is slidably connected to the locating opening (8), the gear (9) is connected to the fixed seat (12), and the shaft (13) is arranged inside the fixed seat (12); the torsion spring (14) is sleeved on the shaft (13); the claw head (15) is connected to the fixed seat (12) through the shaft (13), and the hanging platform (16) is fitted onto the side of the claw head (15) that faces away from the fixed seat (12).

4. The multifunctional cup dispenser according to claim 3, wherein the top wall of the fixed seat (12) is provided with an adjustment slot (17), and an eccentric adjusting pushrod (18) is eccentrically arranged on the bottom of the gear (9); the eccentric adjusting pushrod (18) is slidably connected to the adjustment slot (17).

5. The multifunctional cup dispenser according to claim 2, wherein four sets of adjusting teeth (19) are arranged in an array on the circumferential side wall of the elastic piece (10), and each set of adjusting teeth (19) is meshed with a corresponding gear (9).

6. The multifunctional cup dispenser according to claim 1, wherein the cabinet-mounted seat (2) includes a mounting seat (20) and a silicone ring (21), the mounting seat (20) connects the cup tube (1) and the housing (5), the locating opening (8) passes through the mounting seat (20) at a position corresponding to the housing (5), and the silicone ring (21) is provided at the junction between the mounting seat (20) and the cup tube (1).

7. The multifunctional cup dispenser according to claim 1, wherein the cup pushing assembly (4) comprises a cup pushing spring (22) and a push block (23); the cup pushing spring (22) is arranged on the bottom inner wall of the cup tube (1), and the push block (23) is connected to the cup pushing spring (22) and arranged inside the cup tube (1).

8. The multifunctional cup dispenser according to claim 1, wherein the cup tube (1) is formed from an upper tubular section and a lower tubular section.

9. The multifunctional cup dispenser according to claim 3, wherein the hanging platform (16) is shaped like an inverted “L,” with one side being beveled and the other side being wavy; the beveled side of the hanging platform (16) conforms to the shape of the cup to guide the cup.
